(19) United States
(12) Patent Application Publication
(10) Pub. No.: US 2009/0147301 A1
(43) Pub. Date: Jun. 11, 2009

(54) HOST APPARATUS FOR IMAGE FORMING APPARATUS AND PRINTING ACCOUNT MANAGEMENT METHOD THEREOF

(75) Inventor: Gun-il Lee, Yongin-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/267,831

(22) Filed: Nov. 10, 2008

(30) Foreign Application Priority Data
Dec. 5, 2007 (KR) 2007-125493

(51) Int. Cl. G06F 15/00

(52) U.S. Cl. 358/1.15

(57) ABSTRACT

A printing account management method of a plurality of image forming apparatuses includes: displaying representations of a plurality of image forming apparatuses; generating a printer group including at least two image forming apparatuses selected from the plurality of displayed representations of the image forming apparatuses; and setting account information corresponding to the generated printer group.

### CROSS-REFERENCE TO RELATED APPLICATION

This application claims all benefits accruing under 35 U.S.C. §119 from Korean Patent Application No. 2007-125493, filed on Dec. 5, 2007 in the Korean Intellectual Property Office, the disclosure of which is incorporated herein by reference.

### BACKGROUND OF THE INVENTION

1. Field of the Invention

Example embodiments of apparatuses and methods of the present invention relate to a host apparatus for an image forming apparatus and a printing account management method thereof, and more particularly, to a host apparatus which sets printing account information for a printer group that includes a plurality of image forming apparatuses, and a printing account management method thereof.

2. Description of the Related Art

An image forming apparatus, such as, a printer, photo-copier, a facsimile machine, and a multi-functional product used in an office, for example, receives print commands from a plurality of users. Thus, the image forming apparatus may have preset printing account information with respect to each user, and may determine whether to perform a print operation according to the set account information.

The printing account information includes usage limiting information, such as, a number of print media, such as, print papers, available for each user. If the set number of print paper is exhausted for a user, the user is not allowed to print using the image forming apparatus.

To set such printing account information in a typical image forming apparatus, a user accesses the image forming apparatus, is authenticated, and a printing account is generated for each authenticated user. Then, usage limiting information is inputted with respect to the generated printing account.

However, the above printing account setting process involves a process of setting the usage limiting information for each individual image forming apparatus, which is very complicated and is a source of inconvenience to the user.

Also, a plurality of image forming apparatuses provided in the office may have different functions in some cases. For example, a first printer which provides color prints and a second printer which provides only mono prints may be provided in the office. In this case, if a user exhausts the number of print paper set for the first printer, the user may print further only by using the second printer. So, even if the print should be in color, the user can not help but print using the second printer which only provides a mono print under the typical printing account management scheme.

### SUMMARY OF THE INVENTION

Accordingly, it is an aspect of the present invention to provide a host apparatus in which a user easily sets printing account information with a graphic user interface (GUI), and a printing account management method thereof.

Additional aspects and/or advantages of the invention will be set forth in part in the description which follows and, in part, will be obvious from the description, or may be learned by practice of the invention.

According to another aspect of the present invention, a host apparatus is provided which allows a user to set integrated printing account information with respect to a printer group that includes at least two image forming apparatuses, to improve restricting use of a specific image forming apparatus, and to enhance user's conveniences, and a printing account management method thereof.

The foregoing and/or other aspects of the present invention can be achieved by providing a printing account management method of a plurality of image forming apparatuses, the method including: displaying representations of a plurality of image forming apparatuses via a graphic user interface (GUI); generating a printer group that includes at least two image forming apparatuses selected from the representations of the image forming apparatuses; and setting account information corresponding to the generated printer group.

In example embodiments, the generating of the printer group may include selecting the at least two image forming apparatuses by a drag and drop operation using the GUI. The generating of the printer group may include selecting the at least two image forming apparatuses by touching a touch screen displaying the GUI. The generating of the printer group may include designating a group name of the printer group.

In example embodiments, the setting of the account information may include displaying at least one user ID; and linking the displayed at least one user ID to correspond to the printer group. The account information may include information about a number of print media available for the printer group. The method may further include displaying whether the at least two selected image forming apparatuses are available to perform a printing operation based on the set account information of the printer group. The displaying of the image forming apparatuses may include displaying an operation status of the plurality of image forming apparatuses.

The foregoing and/or other aspects of the present invention can be achieved by providing a host apparatus connected to a plurality of image forming apparatuses, the host apparatus including: a display unit which displays representations of the plurality of image forming apparatuses via a graphic user interface (GUI); a user input unit which receives a user's command; and a controller which generates a printer group that includes at least two image forming apparatuses selected from the representations of the image forming apparatuses and sets account information corresponding to the generated printer group according to the user's command.

In example embodiments, the user input unit may include a mouse, and the controller selects the at least two image forming apparatuses by a drag and drop operation using the mouse via the GUI. The display unit may include a touch screen displaying the GUI, and the controller selects the at least two image forming apparatus through the touch screen. The controller may designate a group name of the printer group according to the user's command.

In example embodiments, the controller may control the display unit to display at least one user ID, and links the at least one of the displayed user ID to correspond to the printer group. The account information may include information about a number of print media available for the printer group. The controller may control the display unit to display whether the at least two selected image forming apparatuses are available to perform a printing operation based on the set account information of the printer group. The controller may control the display unit to display an operation status of the plurality of image forming apparatuses.

According to an example embodiment of the present invention, a method of setting account information for a plurality of image forming apparatuses that are shared by a plurality of users, including: associating the plurality of the image forming apparatuses as a printer group; setting the account information for the printer group; and associating at least one of the users to the printer group so as to limit the at least one of the users from using the plurality of the image forming apparatuses of the printer group.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram of a host apparatus according to an example embodiment of the present invention;

FIGS. 2 and 3 illustrate examples of a graphic user interface (GUI) which is generated and displayed according to an example embodiment of the present invention; and

FIGS. 4 and 5 are flowcharts to describe a printing accounting management method according to an example embodiment of the present invention.

### DETAILED DESCRIPTION OF THE EMBODIMENTS

Reference will now be made in detail to embodiments of the present invention, examples of which are illustrated in the accompanying drawings, wherein like reference numerals refer to the like elements throughout. The example embodiments are described below in order to explain the present invention by referring to the figures.

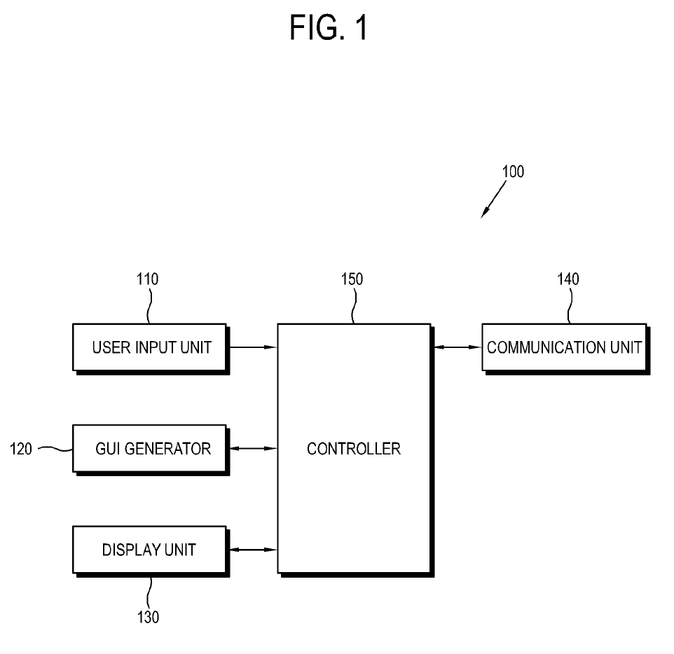

FIG. 1 is a block diagram of a host apparatus 100 according to an example embodiment of the present invention. The host apparatus 100 can be a computer system to transmit and receive data with an image forming apparatus, such as, a printer, a multi-function device, a photocopier, etc. The host apparatus 100 may also include a server which manages a printing account.

As shown in FIG. 1, the host apparatus 100 transmits print data, such as, a text, an image, and/or documents to the image forming apparatus. The image forming apparatus forms the text, the image, and/or the documents on a record medium, such as, paper, based on the transmitted print data. The host apparatus 100 may transmit the print data to one of a plurality of image forming apparatuses.

The host apparatus 100 sets printing account information (hereinafter referred to as account information) with respect to the plurality of image forming apparatuses, and determines whether to print according to the set account information. The account information may include usage limiting information, such as, a number of print papers available for each user to print.

As shown in FIG. 1, the host apparatus 100 includes a user input unit 110, a graphic user interface (GUI) generator 120, a display unit 130, a communication unit 140, and a controller 150. The host apparatus 100 may further include an image processor (not shown) to generate print data, such as, a document, to be printed on a print paper.

The user input unit 110 receives a user's command about the account information and transmits the user's command to the controller 150. The user input unit 110 may be a variety of input devices, such as, a mouse, a keyboard, a touch pad, a stylus pen, and the like. If the display unit 130 which will be described later includes a touch screen, the host apparatus 100 receives the command from the user by a sensed touch of the touch screen.

The GUI generator 120 generates a graphic user interface (GUI) including at least one menu about the account information. The generated GUI is displayed on the display unit 130. In example embodiments of the present invention, the graphic user interface (GUI) is used to set or change the account information.

The display unit 130 displays representations (e.g., icons) of a plurality of image forming apparatuses whose account information is to be set. The display unit 130 may be one that includes a cathode ray tube (CRT), a liquid crystal display (LCD), or a plasma display panel (PDP) as a display module. The display unit 130 may include a touch type display module, such as, a touch screen. In other example embodiments, an organic light emitting diode (OLED) display may be the display module of the display unit 130.

The communication unit 140 performs data communication with the image forming apparatuses or other host apparatuses (including a server) according to a control of the controller 150. That is, the communication unit 140 may transmit information about whether to use the image forming apparatus, to the image forming apparatus together with the print data. The communication unit 140 may include a wired/wireless communication module which is accessible to a network.

The controller 150 controls the host apparatus 100 as a whole. The controller 150 may also manipulate the GUI. More specifically, the controller 150 controls the GUI generator 120 to generate the GUI including a menu to thereby enable selection and control of the plurality of image forming apparatuses, and controls the display unit 130 to display the generated GUI.

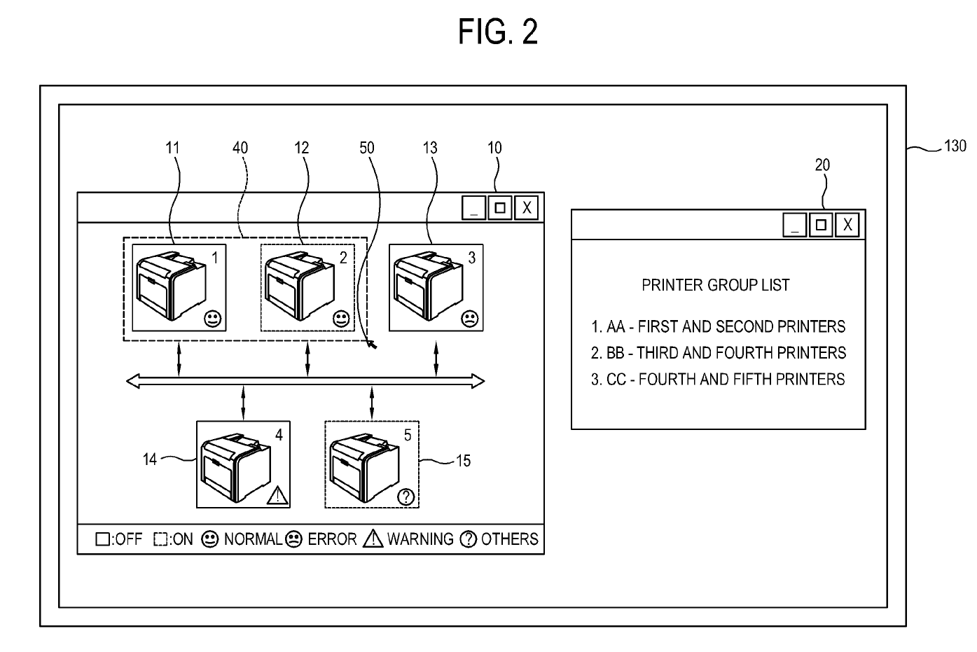

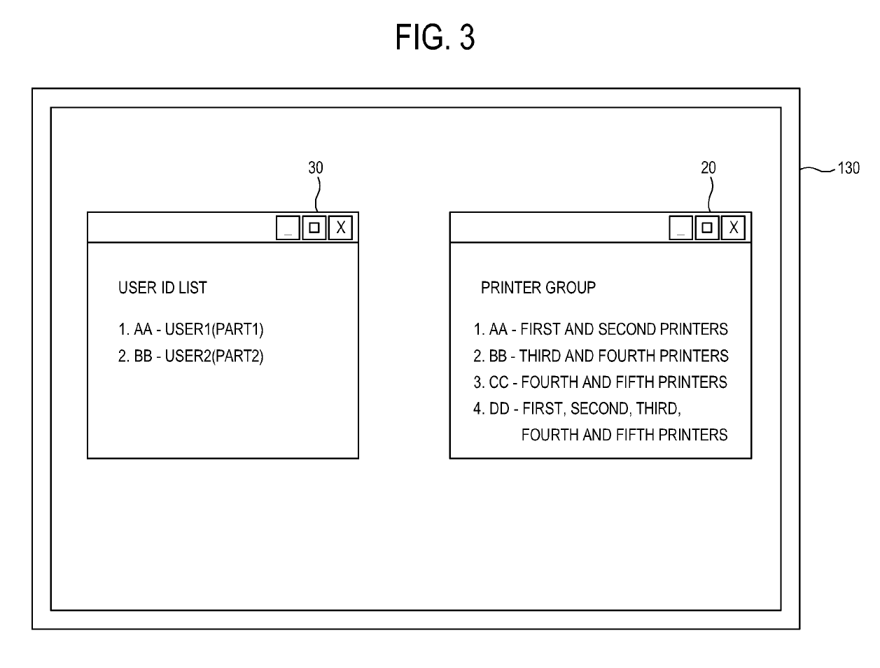

FIGS. 2 and 3 illustrate examples of the GUI generated and displayed according to an example embodiment of the present invention. As shown in FIG. 2, the controller 150 controls the display unit 130 to provide a visual display of a GUI 10 including icons 11 to 15 corresponding to the plurality of image forming apparatuses #1 to #5, and a GUI 20 including a printer group list of printer groups AA, BB, and CC from the plurality of image forming apparatuses #1 to #5.

The display unit 130 may display an operation status of the plurality of image forming apparatuses #1 to #5, i.e., power on/off, normal mode, errors, warning, etc, as shown by various symbols at a bottom of the GUI 10. The printer group list of GUI 20 also includes the plurality of image forming apparatuses #1 to #5 in printer groups AA, BB, and CC. According to the present invention, account information is set with respect to a printer group.

Referring to FIG. 2, the controller 150 may control a cursor 50 to select the icons 11 to 15 of the image forming apparatuses #1 to #5 displayed on the display unit 130 with the user input unit 110, i.e., the mouse, select at least two image forming apparatuses #1 and #2 (via icons 11 and 12) by setting an area 40 from among the icons 11 to 15 of the image forming apparatuses #1 to #5 and use a drag and drop operation to move the icons 11 and 12 of the selected at least two image forming apparatuses #1 and #2 to the GUI 20 including the printer group list so as to generate a new printer group or to add to an existing printer group. Accordingly, the host apparatus 100 may easily select at least two image forming apparatuses to be set as a single printer group. It is understood that taking away from an exiting printer group or deleting an existing printer group is also within the scope of the present invention.

Based on a selection operation in reference to FIG. 2, the GUI 20 including the printer group list contains a printer group AA that includes a first printer #1 and a second printer #2, a printer group BB that includes a third printer #3 and a fourth printer #4, and a printer group CC that includes a fourth printer #4 and a fifth printer #5. In example embodiments of the present invention, the printer groups may include more than two image forming apparatuses, or may simply include one image forming apparatus.

According to another example embodiment of the present invention, the controller 150 may control the cursor 50 to select icons 11 and 12 of the at least two image forming apparatuses #1 and #2 from a touch screen by a user touching from among the icons 11 to 15 of the image forming apparatuses #1 to #5 displayed on the GUI 10 with fingers or a stylus pen, instead of the mouse.

In example embodiments of the present invention, the controller 150 may generate a single printer group that includes at least two selected image forming apparatuses. The controller 150 may control the GUI generator 120 to generate a GUI designating a group name of the generated printer group, and may control the display of the generated group name on the display unit 130. The group name of the generated printer group may be inputted through the user input unit 110 or selected from a group of names provided as a default. Further, the controller 150 sets account information for the generated printer group once generated. In example embodiments of the present invention, the controller 150 may set the account information for the generated printer group using default values, predetermined values, or may prompt the user to input the account information.

More specifically, the controller 150 may display a GUI 30 that includes a registered user ID on the display unit 130 as shown in FIG. 3. The user ID may be assigned to a plurality of users, e.g., to a specific department, as well as to an individual user. The controller 150 makes (or links) at least one of the displayed user IDs to correspond to the generated printer group and provides a usage authority to a specific user ID. Further, the controller 150 may input usage limiting information, such as, a number of print papers available for the set generated printer group.

For example, as shown in FIG. 3, when a new printer group that includes the first to fifth image forming apparatuses #1 to #5 is newly generated while printer groups of AA, BB and CC are in existence, a user may select the icons 11 to 15 of the image forming apparatuses #1 to #5 to be included in the new printer group using the user input unit 110. If the selected image forming apparatuses #1 to #5, i.e., the new printer group including the first to fifth printers (image forming apparatuses #1 to #5) is generated, a group name DD of the new printer group may be generated or inputted through the user input unit 110 when the new printer group DD is made to correspond to the user ID, the user ID may be one that is a preexisting one from the GUI 30, or may be newly generated. Also, it is understood that the group names may be replaced, deleted, or modified.

As shown in FIG. 3, the user makes the new printer group DD to correspond to the user ID list, and inputs the usage limiting information, such as, the number of print paper, thereby easily setting the account information.

When the account information is set, the controller 150 determines availability of the at least two selected image forming apparatuses based on the account information of the set printer group, and controls the display unit 130 to display the availability thereof. That is, the user is allowed to use only the image forming apparatuses of the printer group corresponding to the user's user ID, and as the printing account, such as, the allocated number of print paper is used up, may no longer use the image forming apparatuses included in the printer group. It is understood that once used up, the allocated number of print paper may be replenished or reset by someone with authority, for example, or in other example embodiments, the user's ID may be re-associated with a printer group with non-exhausted account information.

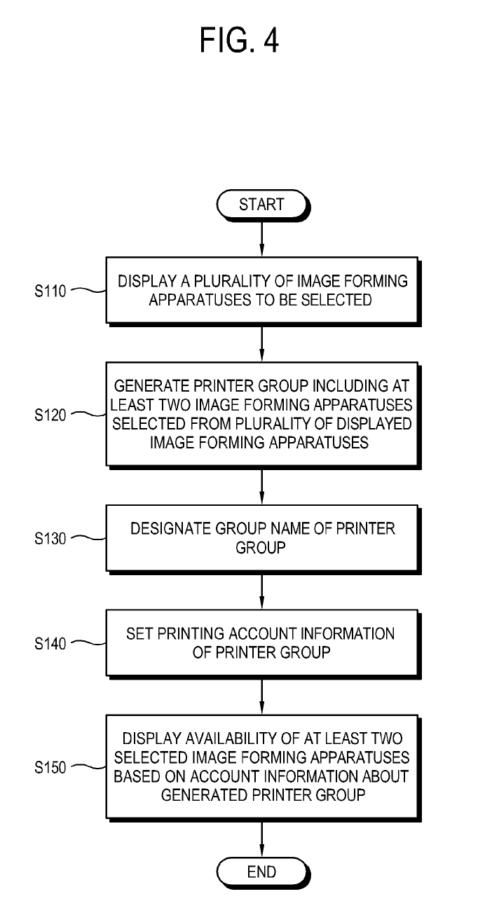

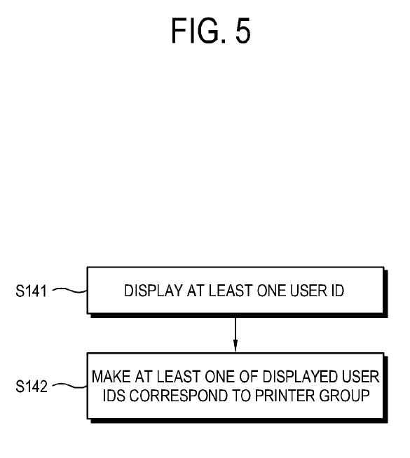

Hereinafter, a printing account management method of the host apparatus 100 having the foregoing configuration will be described with reference to FIGS. 4 and 5. FIG. 4 is a flowchart to describe a printing accounting management method according to an example embodiment of the present invention, and FIG. 5 is flowchart to describe an operation to set account information corresponding to the generated printer group of FIG. 4.

Referring to FIG. 4, the host apparatus 100 displays representations of the plurality of image forming apparatuses on the display unit 130 to be selected (operation S110). The controller 150 may display the operation status of the plurality of image forming apparatuses, i.e., power on/off, a normal mode, errors, warning and the like.

The controller 150 selects at least two image forming apparatuses from the plurality of image forming apparatuses displayed and generates a printer group including the at least two selected image forming apparatuses (operation S120). The controller 150 controls the GUI generator 120 to generate the GUI 10 to display the representation of the plurality of image forming apparatuses and the GUI 20 to display a printer group list, and use a drag and drop operation to move the at least two image forming apparatuses to the printer group list through the user input unit 110. Thus, the controller 150 may select the at least two image forming apparatuses by a user touching two or more of the icons 11 to 15 of the image forming apparatuses 1 to 5 included in the GUI 10 that displays the plurality of image forming apparatuses, with the user's fingers or a stylus pen, for example, to generate a new printer group or to add to an existing printer group.

The controller 150 designates the group name of the generated printer group (operation S130). The group name of the generated printer group may be inputted through the user input unit 110 or selected from group names provided as a default. The controller 150 sets the account information corresponding to the generated printer group (operation S140).

Specifically, with reference to FIG. 5, the account information may include user information with respect to the generated printer group. The controller 150 may display at least one registered user ID (operation S141), and correspond at least one of the displayed user IDs to the printer group (operation S142). The account information may include information about the number of print papers available for the printer group. When the account information is set at operation S140, the controller 150 displays whether the at least two selected image forming apparatuses are available based on the account information of the set printer group (operation S150).

In example embodiments, a host apparatus includes a computer, a personal digital assistant (PDA), a mobile phone, a portable multimedia player (PMP), an MP3 player, a digital camera, a digital video recorder, and other electronic devices capable of communicating through a network.

As described above, a host apparatus for an image forming apparatus and a printing account management method thereof according to example embodiments of the present invention allows a user to easily set printing account information with a GUI for a plurality of grouped image forming apparatuses.

Also, a host apparatus and a printing account management method thereof according to example embodiments of the present invention allows a user to set integrated printing account information with respect to a printer group including at least two image forming apparatuses, improves utility of a specific image forming apparatus and enhances user's conveniences.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the graphic user interface (GUI) may be used to set or change the account information; an organic light emitting diode (OLED) display may be the display module of the display unit 130; image forming apparatus may be deleted from an existing printer group, or existing printer groups may be deleted; the controller 150 may set the account information for the generated printer group using default values, predetermined values, or may prompt the user to input the account information; and the group names may be replaced, deleted, or modified. Accordingly, it is intended, therefore, that the present invention not be limited to the various example embodiments disclosed, but that the present invention includes all embodiments falling within the scope of the appended claims.

What is claimed is:

1. A printing account management method of a plurality of image forming apparatuses, the method comprising:
displaying representations of a plurality of image forming apparatuses via a graphic user interface (GUI);
generating a printer group that includes at least two image forming apparatuses selected from the representations of the image forming apparatuses; and
setting account information corresponding to the generated printer group.

2. The method according to claim 1, wherein the generating of the printer group comprises selecting the at least two image forming apparatuses by a drag and drop operation using the GUI.

3. The method according to claim 1, wherein the generating of the printer group comprises selecting the at least two image forming apparatuses by touching a touch screen displaying the GUI.

4. The method according to claim 1, wherein the generating of the printer group comprises designating a group name of the printer group.

5. The method according to claim 1, wherein the setting of the account information comprises displaying at least one user ID; and
linking the displayed at least one user ID to correspond to the printer group.

6. The method according to claim 1, wherein the account information comprises information about a number of print media available for the printer group.

7. The method according to claim 1, further comprising displaying whether the at least two selected image forming apparatuses are available to perform a printing operation based on the set account information of the printer group.

8. The method according to claim 1, wherein the displaying of the image forming apparatuses comprises displaying an operation status of the plurality of image forming apparatuses.

9. A host apparatus connected to a plurality of image forming apparatuses, the host apparatus comprising:
a display unit which displays a representation of the plurality of image forming apparatuses via a graphic user interface (GUI);
a user input unit which receives a user's command; and
a controller which generates a printer group that includes at least two image forming apparatuses selected from the representations of the image forming apparatuses and sets account information corresponding to the generated printer group according to the user's command.

10. The host apparatus according to claim 9, wherein the user input unit comprises a mouse, and
the controller selects the at least two image forming apparatuses by a drag and drop operation using the mouse via the GUI.

11. The host apparatus according to claim 9, wherein:
the display unit comprises a touch screen displaying the GUI, and
the controller selects the at least two image forming apparatus through the touch screen.

12. The host apparatus according to claim 9, wherein the controller designates a group name of the printer group according to the user's command.

13. The host apparatus according to claim 9, wherein the controller controls the display unit to display at least one user ID, and links the at least one of the displayed user ID to correspond to the printer group.

14. The host apparatus according to claim 9, wherein the account information comprises information about a number of print media available for the printer group.

15. The host apparatus according to claim 9, wherein the controller controls the display unit to display whether the at least two selected image forming apparatuses are available to perform a printing operation based on the set account information of the printer group.

16. The host apparatus according to claim 9, wherein the controller controls the display unit to display an operation status of the plurality of image forming apparatuses.

17. A method of setting account information for a plurality of image forming apparatuses that are shared by a plurality of users, comprising:
associating the plurality of the image forming apparatuses as a printer group;
setting the account information for the printer group; and
associating at least one of the users to the printer group so as to limit the at least one of the users from using the plurality of the image forming apparatuses of the printer group.

18. The method of claim 17, wherein the account information includes a number of print media available for printing for the printer group.

19. The method of claim 17, wherein the associating of the at least one of the users to the printer group includes associating a user ID corresponding to the at least one of the users to the printer group.

20. A host apparatus connected to the plurality of image forming apparatuses, and comprising a controller to perform the method of claim 17.
